(19) United States
(12) Patent Application Publication
(10) Pub. No.: US 2026/0016880 A1
(43) Pub. Date: Jan. 15, 2026

(54) SYSTEM AND METHOD FOR TRAFFIC RESHAPING FOR DDR LOW POWER CONTROL

(71) Applicant: Samsung Electronics Co., Ltd., Gyeonggi-do (KR)

(72) Inventors: Li YANG, Austin, TX (US); Yunkyo CHO, Austin, TX (US); Junhee YOO, Yongin (KR); Manhwee JO, Seoul (KR); Tarun KATHURIA, San Diego, CA (US); Keshav RAHEJA, Austin, TX (US)

(21) Appl. No.: 19/268,515

(22) Filed: Jul. 14, 2025

Related U.S. Application Data
(60) Provisional application No. 63/670,448, filed on Jul. 12, 2024.

(51) Int. Cl. G06F 1/3234; G06F 1/3225

(52) U.S. Cl. CPC G06F 1/3275; G06F 1/3225

(57) ABSTRACT

A system and a method are disclosed for managing memory traffic in a memory device. The method includes delaying processing of the memory traffic based on a request threshold and a time threshold; and initiating or maintaining a power-down state of the memory device during a period in which the memory traffic is delayed.

### CROSS-REFERENCE TO RELATED APPLICATION

This application claims the priority benefit under 35 U.S.C. § 119 (e) of U.S. Provisional Application No. 63/670,448, filed on Jul. 12, 2024, the entire contents of which are incorporated herein by reference.

### TECHNICAL FIELD

The disclosure generally relates to memory management techniques in computing systems. More particularly, the subject matter disclosed herein relates to improvements to dynamic power-down control in double data rate (DDR) memory systems by selectively reshaping memory traffic to enhance opportunities for entering and remaining in low-power states.

### SUMMARY

DDR memory systems are frequently a part of modern computing platforms, particularly in system-on-chip (SoC) designs for mobile, artificial intelligence (AI), and data center applications. To reduce power consumption, these systems support low-power states, such as power-down modes, in which the memory interface deactivates portions of the circuitry when idle. Efficient entry into and staying in such low-power states can yield substantial energy savings, especially in devices operating under various battery constraints. However, achieving consistent entry into and prolonged use of these low-power states is often challenged by irregular memory traffic patterns.

To solve this problem, some DDR memory controllers can employ idle-count mechanisms. These mechanisms may monitor traffic for periods of inactivity and trigger a transition into a power-down state once a predefined idle duration threshold is met. When new traffic is detected, the controller may exit the power-down state to process pending requests.

One issue with the above approach is that when traffic is scattered over time, such as intermittent or low-throughput workloads, the memory may not stay idle long enough to enter power-down mode, or may exit prematurely due to transient requests. This can result in frequent transitions or complete avoidance of low-power states, reducing the effectiveness of the power-saving mechanisms.

To overcome these issues, systems and methods are described herein for dynamically reshaping memory traffic to increase the likelihood and duration of DDR memory entering and remaining in a low-power power-down state. According to various embodiments, incoming traffic can be temporarily withheld and aggregated based on programmable thresholds, including a request count threshold and/or a timeout threshold. In cases where the thresholds are not met, the system can delay memory access and allow the dynamic random-access memory (DRAM) to either stay in or enter the power-down state. Once either or both thresholds are met, the withheld traffic can be released, and if necessary, the memory may exit the low-power state to service the requests. Thresholds may be static or dynamically adjusted based on traffic patterns, voltage or frequency scaling modes, or system-level policies.

The above approaches improve on previous methods because they enable the controller to reshape scattered memory requests into clustered patterns, thereby increasing both the frequency and duration of low-power state usage. As a result, overall DDR power consumption can be significantly reduced without materially impacting system performance, and latency overheads can be mitigated through threshold tuning or urgent overrides when needed.

According to an aspect of the disclosure, a method for managing memory traffic in a memory device includes delaying processing of the memory traffic based on a request threshold and a time threshold; and initiating or maintaining a power-down state of the memory device during a period in which the memory traffic is delayed.

According to another aspect of the disclosure, a memory device for managing memory traffic is provided. The memory device includes a traffic reshaping device configured to delay processing of the memory traffic based on a request threshold and a time threshold; and a memory controller configured to initiate or maintain a power-down state of the memory device during a period in which the memory traffic is delayed.

### BRIEF DESCRIPTION OF THE DRAWING

In the following section, the aspects of the subject matter disclosed herein will be described with reference to exemplary embodiments illustrated in the figures, in which:

FIG. 1 illustrates an example architecture of a device for implementing traffic reshaping in an SoC environment, according to an embodiment;

FIG. 2 is a timing diagram illustrating an example DRAM power-down control process in the absence of traffic reshaping, according to an embodiment;

FIG. 3 is a timing diagram illustrating an example DRAM power-down control process using traffic reshaping, according to an embodiment;

FIG. 4 is a flowchart illustrating a power-down control procedure based on traffic activity in the absence of traffic reshaping, according to an embodiment;

FIG. 5 is a flowchart illustrating a power-down control procedure based on traffic activity using traffic reshaping, according to an embodiment;

FIG. 6 is a flowchart illustrating a method for managing memory traffic in a memory device, according to an embodiment; and

FIG. 7 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), SoC, an assembly, and so forth.

“DDR”, as used herein, refers to double data rate, which is a signaling technique used in DRAM systems in which data is transferred on both the rising and falling edges of a clock signal. Some examples of DDR include DDR3, DDR4, and DDR5, each defined by corresponding Joint Electron Device Engineering Council (JEDEC) standards. DDR may be used to increase memory bandwidth without increasing the base clock frequency.

“Traffic reshaping”, as used herein, refers to a process performed by a traffic reshaping device to modify the timing of memory traffic in order to increase the likelihood or duration of a power-down state in a memory device. Some examples of traffic reshaping include delaying memory traffic based on a request threshold and/or a time threshold, and releasing the memory traffic after one or more thresholds are met.

“Traffic reshaping device” (or “traffic reshape device”), as used herein, refers to hardware, firmware, or logic configured to perform traffic reshaping. Some examples of a traffic reshaping device include circuitry configured to monitor memory traffic, maintain one or more counters, compare the counters to thresholds, and/or delay or release memory traffic based on the comparison. In some embodiments, the traffic reshaping device may be included in a memory controller or in a memory device.

“Memory traffic”, as used herein, refers to data or control transactions directed to or from a memory device. Some examples of memory traffic include read commands, write commands, refresh operations, and other memory access commands. Memory traffic may originate from one or more components in a system and may vary in frequency and timing.

“Power-down state”, as used herein, refers to a low-power operating mode of a memory device in which one or more internal components are deactivated to reduce power consumption. Some examples of a power-down state include idle power-down, in which all banks are precharged, and/or active power-down, in which one or more banks remain active while command processing is suspended.

“Memory device”, as used herein, refers to one or more hardware components configured to store data and respond to memory access commands. Some examples of a memory device include DRAM, DDR memory, and/or high-bandwidth memory (HBM). A memory device may support one or more power-down states.

“Memory controller”, as used herein, refers to hardware or logic configured to control access to a memory device. Some examples of a memory controller include one or more processors or components configured to schedule memory commands, manage timing constraints, and/or control entry into or exit from a power-down state. In some embodiments, a memory controller may include or communicate with a traffic reshaping device.

“Request threshold”, as used herein, refers to a configurable value that specifies one or more memory requests to accumulate before releasing delayed memory traffic for processing. Some examples of a request threshold include fixed values or dynamically determined values that are used to control traffic reshaping. A request threshold may be used to cluster memory traffic into bursts.

“Time threshold”, as used herein, refers to a configurable value that specifies a duration for delaying memory traffic. Some examples of a time threshold include one or more values measured in clock cycles from the first memory request following an idle period. A time threshold may be used to ensure that memory traffic is released within a bounded time duration even if a request threshold is not met.

Reducing overall power consumption is an objective in modern SoC design, particularly for battery-powered mobile devices and high-performance computing platforms such as AI accelerators and data center infrastructure, where energy efficiency directly impacts thermal limits and operational cost. Among the various contributors to SoC power usage, DDR DRAM is often a significant source of consumption.

To mitigate this, DDR DRAM devices can support one or more low-power modes, including a power-down state in which I/O buffers are deactivated, excluding higher priority signals such as reset, thereby reducing power consumption relative to standard operational states such as idle. DRAM controllers may include dynamic power-down control logic that transitions the DRAM device into a power-down state when inactivity is detected for a threshold duration, and exits the power-down state upon the detection of memory activity or traffic.

In various embodiments described herein, traffic reshaping is introduced to improve the efficiency of such dynamic power-down control. In addition to the description of traffic reshaping mentioned above, traffic reshaping may also refer to the intentional reordering or delaying of memory requests in order to increase the likelihood of entering the DRAM power-down state, and to extend the duration of time the memory device remains in that state. In addition to enabling longer low-power periods, traffic reshaping may also reduce the total number of activate commands issued to DRAM banks, further lowering energy consumption. This approach may be particularly beneficial in scenarios where traffic is scattered or intermittent, which would otherwise prevent entry into power-down states under idle-count-based control mechanisms.

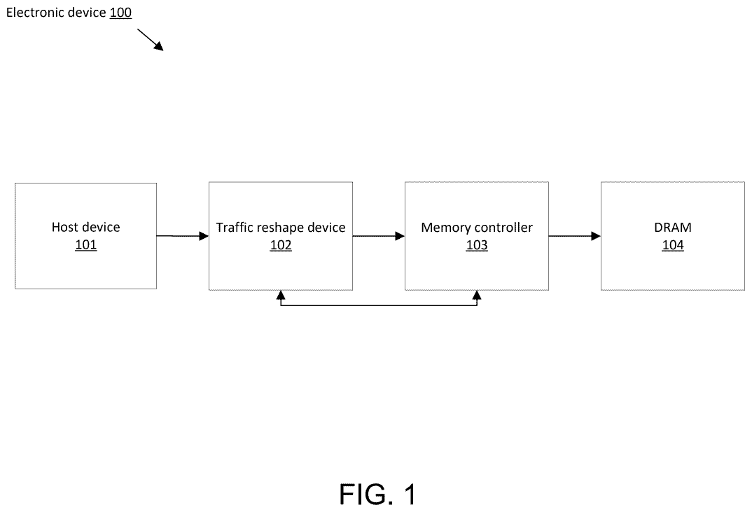

FIG. 1 illustrates an example architecture of a device for implementing traffic reshaping in an SoC environment, according to an embodiment.

Referring to FIG. 1, electronic device 100 includes host device 101, traffic reshape device 102, memory controller 103, and DRAM 104. It will be understood that the components illustrated in FIG. 1 are provided for illustrative purposes and need not be implemented as discrete hardware blocks, and one or more components may be combined into the same hardware block. In various embodiments, two or more of host device 101, traffic reshape device 102, memory controller 103, and DRAM 104 may be integrated within a common integrated circuit or SoC, or alternatively may be implemented as separate devices communicatively coupled through one or more interfaces, interconnects, or buses. The arrangement and distribution of these components may vary depending on the implementation and should not be construed as limiting.

Host device 101 may include one or more processing elements, such as a central processing unit (CPU), graphical processing unit (GPU), image signal processor (ISP), or other components capable of issuing memory requests. These memory requests may correspond to reads, writes, or other transactions directed toward a memory subsystem. The host device 101 may generate traffic that is routed to a traffic reshape device 102, which acts as an intermediate processing module positioned logically between the host and the memory controller. The traffic reshape device 102 may be included in the host device 101, or may be external to the host device 101.

The traffic reshape device 102 may monitor the stream of incoming memory requests from the host device 102 and apply dynamic scheduling logic to temporarily withhold and aggregate requests based on configurable thresholds. These thresholds may include, for example, a request count threshold that specifies a minimum number of pending transactions required before forwarding the pending transactions, and a timeout threshold that limits the maximum delay before release of the pending transactions. A purpose of this logic may be to reshape scattered or low-intensity memory traffic into clustered bursts, thereby reducing memory bus activity during low-traffic intervals. The traffic reshape device 102 may receive feedback from downstream components, such as the memory controller 103, indicating whether the DRAM is currently in, or eligible to enter, a low-power state, and may use this information to decide whether to continue delaying traffic or initiate release.

Reshaped memory requests may be passed from the traffic reshape device 102 to a memory controller 103, which may be responsible for converting these requests into appropriate command sequences. The memory controller 103 may include command schedulers, row-buffer management logic, and timing control circuitry in accordance with the DRAM protocol being used (e.g., DDR4, DDR5, or HBM). In addition to issuing commands to service memory requests, the memory controller 103 may manage the DRAM's low-power state transitions, by detecting inactivity windows, initiating entry into idle power-down or active power-down modes, and/or generating wake-up signals when traffic resumes. The memory controller 103 may also communicate power state information or timing constraints back to the traffic reshape device 102 to guide its delay logic.

The DRAM device 104 may receive command sequences from the memory controller 103 and execute corresponding operations such as activating a row, performing a read operating, and/or performing a write operation. In various embodiments, DRAM 104 may support multiple low-power modes, such as idle power-down (entered when the device is idle) and active power-down (entered while banks in DRAM 104 are active but the command bus is idle).

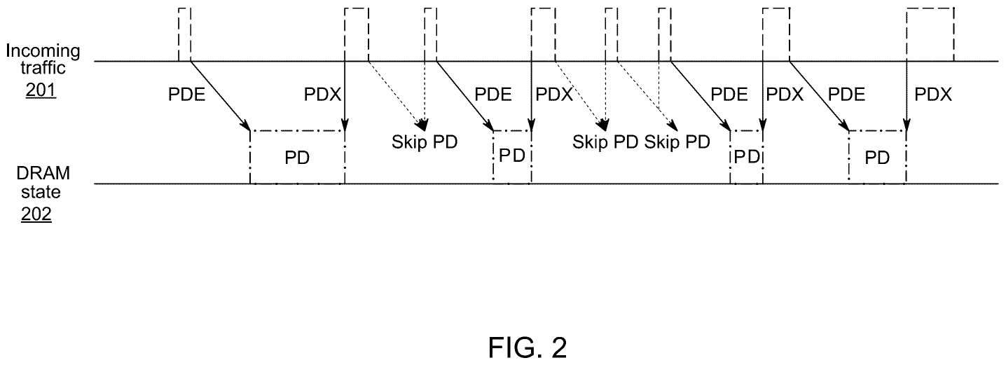

FIG. 2 is a timing diagram illustrating an example DRAM power-down control process in the absence of traffic reshaping, according to an embodiment.

Referring to FIG. 2, the upper timeline labeled incoming traffic 201 shows a sequence of memory requests represented by vertical bars, which arrive in a scattered pattern over time. These requests may originate from one or more host components generating sporadic traffic to the memory subsystem. The lower timeline labeled DRAM state 202 shows the corresponding transitions of the DRAM device, including power-down entry (PDE), power-down (PD), and power-down exit (PDX) events. As illustrated, when a sufficient idle period is detected between requests, the DRAM transitions into the PD state via a PDE command. However, if traffic arrives shortly thereafter, a PDX is issued, forcing the DRAM to exit the power-down state prematurely. In some cases, such as those indicated by the labels skip PD, incoming traffic requests arrive before the system enters a PD state, and the system does not initiate PDE. Accordingly, short idle intervals limit the use of DRAM low-power states and reduce the potential for energy savings.

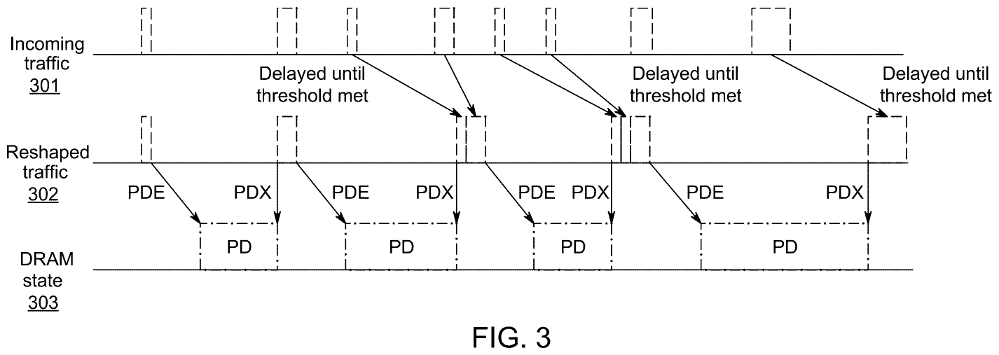

FIG. 3 is a timing diagram illustrating an example DRAM power-down control process using traffic reshaping, according to an embodiment.

Referring to FIG. 3, the upper timeline shows incoming traffic 301 as scattered individual requests. In this case, however, the intermediate reshaped traffic timeline 302 demonstrates the operation of a traffic reshape device, which temporarily delays incoming requests until either a request count threshold or a timeout condition is met. These reshaped traffic bursts, shown as more clustered and periodic than incoming traffic, are then forwarded to the memory controller. As shown in the lower timeline, the DRAM state 303 transitions reflect longer and more stable periods in the PD state than in the DRAM state 202 of FIG. 2. Each PDE-PD-PDX iteration may be defined as one cycle, and may correspond to a reshaped idle window for entering and remaining in the power-down state. Accordingly, the reshaping mechanism may prevent premature wake-ups and minimize short, fragmented idle windows, enabling improved low-power operation compared to the scenario depicted in FIG. 2.

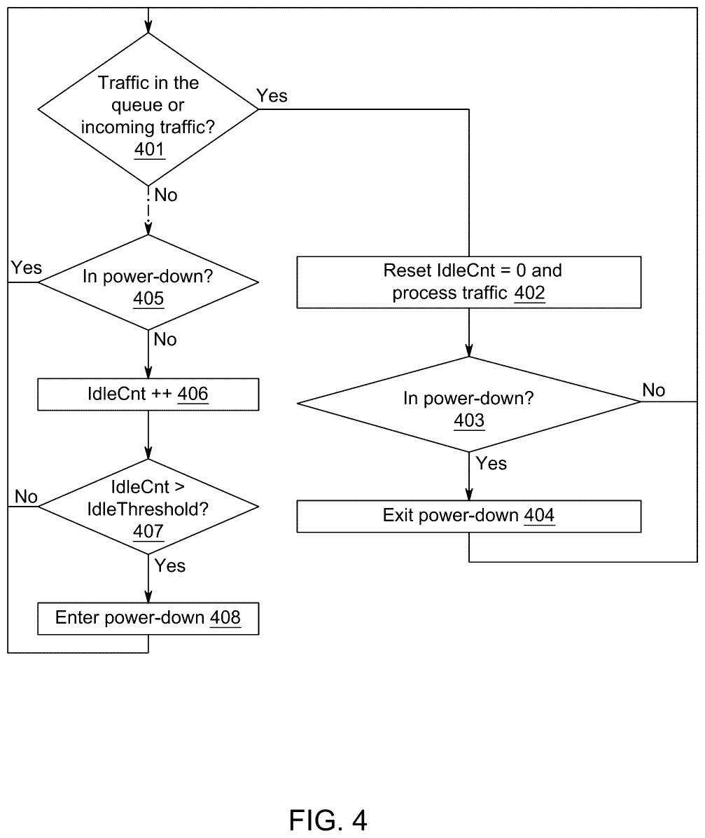

FIG. 4 is a flowchart illustrating a power-down control procedure based on traffic activity in the absence of traffic reshaping, according to an embodiment.

The steps illustrated in FIG. 4 may be performed by any suitable control logic configured to manage memory traffic and power states, including but not limited to a memory controller integrated within an SoC, a dedicated DRAM controller, or a power management unit (PMU) operating in coordination with memory scheduling logic.

Referring to FIG. 4, at step 401, the controller determines whether there is traffic in the queue or any new incoming traffic from the host. If traffic is present (Yes from step 401), the process proceeds to step 402. In step 402, the controller resets the idle counter (IdleCnt) to zero and proceeds to process the incoming traffic.

Following this, in step 403, the controller determines whether the DRAM is currently in a power-down state. If it is (Yes from step 403), the controller issues a command to exit power-down mode at step 404 and returns to step 401 to evaluate traffic in the next cycle. If the DRAM is not in power-down state (No from step 403), the system returns directly to step 401 to evaluate traffic in the next cycle.

If, at step 401, no traffic is detected (No from step 401), the process continues to step 405, where the controller checks whether the DRAM is already in power-down. If it is (Yes from step 405), the controller maintains the current state and returns to step 401 for the next evaluation cycle.

If the DRAM is not in power-down (No from step 405), the process proceeds to step 406, where the idle counter (IdleCnt) is incremented by one. This counter tracks how many cycles have passed without traffic. Next, in step 407, the controller compares the idle counter to a predefined threshold value (IdleThreshold). If the idle counter has not yet exceeded the threshold (No from step 407), the process returns to step 401. If the idle counter has exceeded the threshold (Yes from step 407), the process advances to step 408, where the controller issues a command to enter the DRAM power-down state.

This flowchart demonstrates a power-saving mechanism in which the DRAM enters the power-down state after a sustained period of inactivity, as measured by the idle counter. However, in scenarios where traffic arrives in small, scattered bursts, this approach may frequently reset the idle counter and prevent entry into low-power mode, underscoring a motivation for the traffic reshaping techniques.

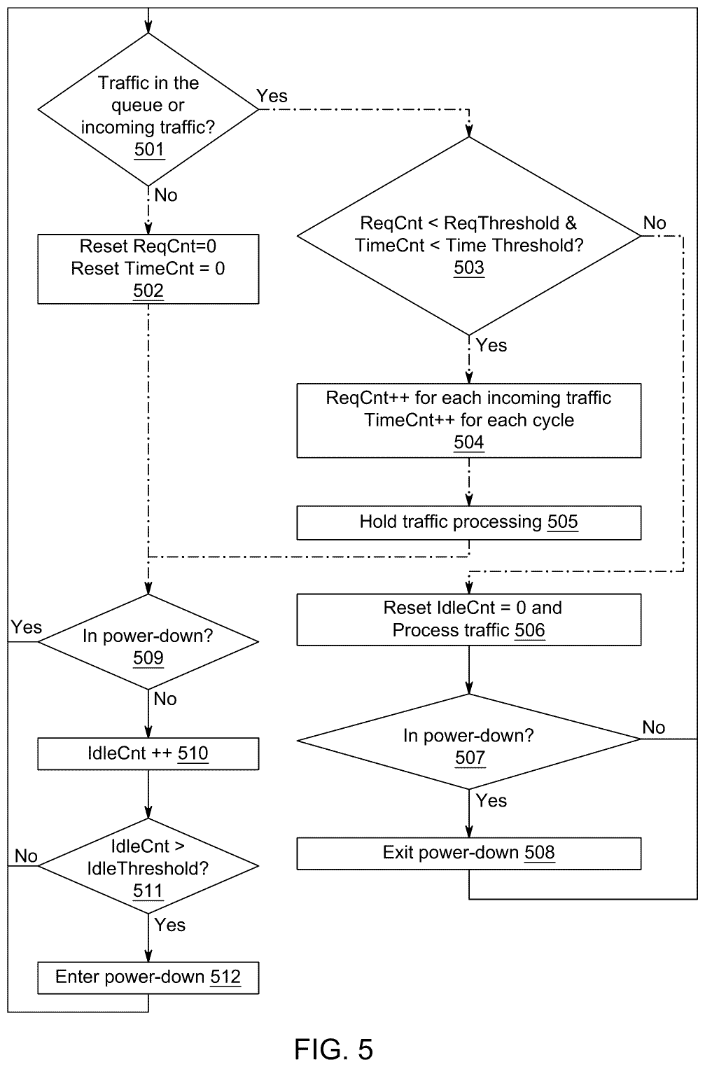

FIG. 5 is a flowchart illustrating a power-down control procedure based on traffic activity using traffic reshaping, according to an embodiment.

The steps illustrated in FIG. 5 may be performed by any suitable control logic configured to manage memory traffic and power states, including but not limited to a memory controller integrated within an SoC, a dedicated DRAM controller, or a PMU operating in coordination with memory scheduling logic.

Referring to FIG. 5, at step 501, the controller determines whether there is traffic in the queue or any new incoming traffic from the host. If no traffic is detected (No from step 501), the controller resets both the request counter (ReqCnt) and time counter (TimeCnt) to zero at step 502. These counters are used to measure the amount of traffic and elapsed time, respectively, since the system transitioned from an idle state.

If traffic is present (Yes from step 501), the process proceeds to step 503, where the controller evaluates whether both ReqCnt and TimeCnt respectively remain below a request threshold (ReqThreshold) and a time threshold (TimeThreshold). If both counters are still within range (Yes from step 503), the controller increments ReqCnt by one for each incoming memory request and increments TimeCnt by one for each clock cycle, as shown in step 504. The process then proceeds to step 505, where the controller holds traffic processing, temporarily delaying the forwarding of requests to the memory controller. This intentional hold creates an opportunity for DRAM to remain idle, increasing the likelihood of entering or maintaining a power-down state.

If either ReqCnt or TimeCnt exceed their configured thresholds (No from step 503), the process proceeds to step 506, where traffic processing is resumed and the idle counter (IdleCnt) is reset to zero. The controller then evaluates whether the DRAM is currently in power-down at step 507. If the DRAM is in power-down (Yes from step 507), the controller issues a power-down exit command at step 508. Otherwise (No from step 507), the system returns to step 501. Accordingly, if traffic is being held or if there is no traffic, the system continues evaluating power-down eligibility.

At step 509, the controller checks whether the DRAM is currently in power-down. If not (No from step 509), the idle counter (IdleCnt) is incremented by one at step 510. The controller then evaluates at step 511 whether IdleCnt has exceeded a pre-defined idle threshold (IdleThreshold). If the threshold is exceeded (Yes from step 511), the DRAM is transitioned into the power-down state at step 512. If not (No from step 511), or if the DRAM is already in power-down (Yes from step 509), the operation returns to step 501.

Accordingly, the logic shown in FIG. 5 introduces two additional counters, ReqCnt and TimeCnt used in implementations. These counters enable fine-grained control over how traffic is reshaped and when it is released. By withholding traffic until either the request count or time count (delay time) reaches a threshold, the system increases the chance that DRAM can enter or remain in a low-power state. The thresholds themselves may be statically configured or dynamically adapted based on operating conditions, such as dynamic voltage and frequency scaling (DVFS), workload priority, or user-defined policies.

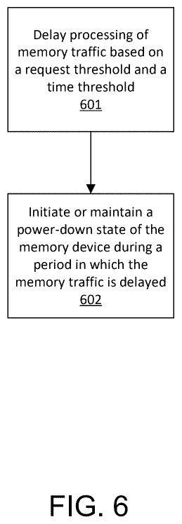

FIG. 6 is a flowchart illustrating a method for managing memory traffic in a memory device, according to an embodiment. The steps shown in FIG. 6 may be performed in the order illustrated or in a different order, and one or more steps may be performed concurrently or omitted. The steps may be performed by a traffic reshaping device, a memory controller, or other control logic included in or coupled to the memory device. In some embodiments, the steps may be implemented in hardware, firmware, or a combination thereof.

Referring to FIG. 6, at step 601, the system delays processing of memory traffic based on a request threshold and a time threshold. The delay may be performed by a traffic reshaping device, which may monitor memory traffic and apply one or more threshold conditions before allowing the memory traffic to proceed to a memory controller. At step 602, the system initiates or maintains a power-down state of the memory device during a period in which the memory traffic is delayed. The power-down state may include an idle power-down state or an active power-down state, and may be sustained until the memory traffic is released or otherwise processed. The operations shown in FIG. 6 may be performed continuously or repeatedly in response to changes in memory traffic patterns or system operating conditions.

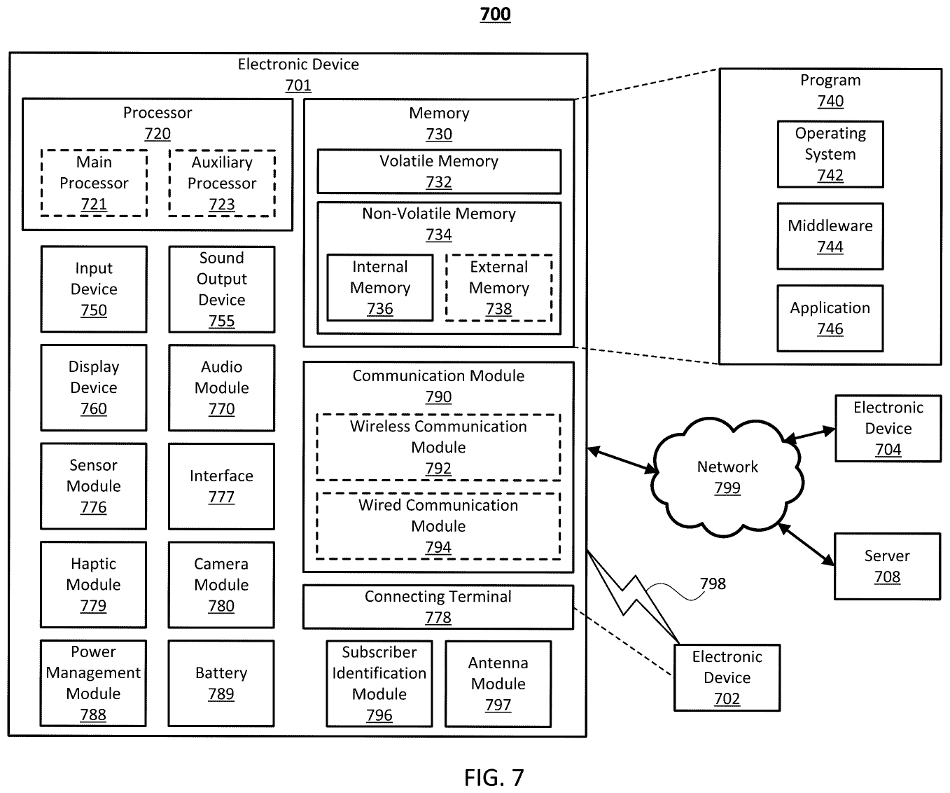

FIG. 7 is a block diagram of an electronic device in a network environment, according to an embodiment.

Referring to FIG. 7, an electronic device 701 (e.g., a memory device) in a network environment 700 may communicate with an electronic device 702 via a first network 798 (e.g., a short-range wireless communication network), or an electronic device 704 or a server 708 via a second network 799 (e.g., a long-range wireless communication network). The electronic device 701 may communicate with the electronic device 704 via the server 708. The electronic device 701 may include a processor 720 (e.g., a controller or a memory controller), a memory 730, an input device 750, a sound output device 755, a display device 760, an audio module 770, a sensor module 776, an interface 777, a haptic module 779, a camera module 780, a power management module 788, a battery 789, a communication module 790, a subscriber identification module (SIM) card 796, or an antenna module 797. In one embodiment, at least one (e.g., the display device 760 or the camera module 780) of the components may be omitted from the electronic device 701, or one or more other components may be added to the electronic device 701. Some of the components may be implemented as a single integrated circuit (IC). For example, the sensor module 776 (e.g., a fingerprint sensor, an iris sensor, or an illuminance sensor) may be embedded in the display device 760 (e.g., a display).

The processor 720 may execute software (e.g., a program 740) to control at least one other component (e.g., a hardware or a software component) of the electronic device 701 coupled with the processor 720 and may perform various data processing or computations.

In one embodiment, the memory 730 may store instructions that, when executed by the processor 720, cause the processor 720 to perform traffic reshaping operations for managing memory traffic and improving power-down control in a memory device, as described in the present disclosure. For example, the processor 720 may maintain a request counter and a time counter in memory 730 and compare their values to corresponding thresholds to determine whether to delay processing of incoming traffic. When both the request counter and the time counter are below their respective thresholds, the processor 720 may be configured to delay transmission of memory requests to a memory controller within the memory device, such as a DRAM module included in or interfaced with the electronic device 701. The memory 730 may also store programmable threshold values or policies that influence the reshaping behavior, such as adjustments based on DVFS states or user-defined latency tolerance levels.

The communication module 790 and interface 777 may facilitate external data transfers and command signaling with memory subsystems or peripheral components, while the power management module 788 may cooperate with the processor 720 to initiate or maintain a low-power mode of the memory device during periods when memory traffic is delayed. Accordingly, the described electronic device structure provides a specific hardware configuration for performing the claimed method steps. The described improvements to achieve a power-down state are realized through specific technical interactions between components including the processor 720, memory 730, and power management module 788, operating in conjunction to reduce power consumption and extend the effective idle duration of DRAM components in the device, thereby saving power and improving memory efficiency.

As at least part of the data processing or computations, the processor 720 may load a command or data received from another component (e.g., the sensor module 776 or the communication module 790) in volatile memory 732, process the command or the data stored in the volatile memory 732, and store resulting data in non-volatile memory 734. The processor 720 may include a main processor 721 (e.g., a CPU or an application processor (AP)), and an auxiliary processor 723 (e.g., a GPU or an ISP), a sensor hub processor, or a communication processor (CP)) that is operable independently from, or in conjunction with, the main processor 721. Additionally or alternatively, the auxiliary processor 723 may be adapted to consume less power than the main processor 721, or execute a particular function. The auxiliary processor 723 may be implemented as being separate from, or a part of, the main processor 721.

The auxiliary processor 723 may control at least some of the functions or states related to at least one component (e.g., the display device 760, the sensor module 776, or the communication module 790) among the components of the electronic device 701, instead of the main processor 721 while the main processor 721 is in an inactive (e.g., sleep) state, or together with the main processor 721 while the main processor 721 is in an active state (e.g., executing an application). The auxiliary processor 723 (e.g., an image signal processor or a communication processor) may be implemented as part of another component (e.g., the camera module 780 or the communication module 790) functionally related to the auxiliary processor 723.

The memory 730 may store various data used by at least one component (e.g., the processor 720 or the sensor module 776) of the electronic device 701. The various data may include, for example, software (e.g., the program 740) and input data or output data for a command related thereto. The memory 730 may include the volatile memory 732 or the non-volatile memory 734. Non-volatile memory 734 may include internal memory 736 and/or external memory 738.

The program 740 may be stored in the memory 730 as software, and may include, for example, an operating system (OS) 742, middleware 744, or an application 746.

The input device 750 may receive a command or data to be used by another component (e.g., the processor 720) of the electronic device 701, from the outside (e.g., a user) of the electronic device 701. The input device 750 may include, for example, a microphone, a mouse, or a keyboard.

The sound output device 755 may output sound signals to the outside of the electronic device 701. The sound output device 755 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 760 may visually provide information to the outside (e.g., a user) of the electronic device 701. The display device 760 may include, for example, a display, a hologram device, or a projector and control circuitry to control a corresponding one of the display, hologram device, and projector. The display device 760 may include touch circuitry adapted to detect a touch, or sensor circuitry (e.g., a pressure sensor) adapted to measure the intensity of force incurred by the touch.

The audio module 770 may convert a sound into an electrical signal and vice versa. The audio module 770 may obtain the sound via the input device 750 or output the sound via the sound output device 755 or a headphone of an external electronic device 702 directly (e.g., wired) or wirelessly coupled with the electronic device 701.

The sensor module 776 may detect an operational state (e.g., power or temperature) of the electronic device 701 or an environmental state (e.g., a state of a user) external to the electronic device 701, and then generate an electrical signal or data value corresponding to the detected state. The sensor module 776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 777 may support one or more specified protocols to be used for the electronic device 701 to be coupled with the external electronic device 702 directly (e.g., wired) or wirelessly. The interface 777 may include, for example, a high-definition multimedia interface (HDMI), a universal serial bus (USB) interface, a secure digital (SD) card interface, or an audio interface.

A connecting terminal 778 may include a connector via which the electronic device 701 may be physically connected with the external electronic device 702. The connecting terminal 778 may include, for example, an HDMI connector, a USB connector, an SD card connector, or an audio connector (e.g., a headphone connector).

The haptic module 779 may convert an electrical signal into a mechanical stimulus (e.g., a vibration or a movement) or an electrical stimulus which may be recognized by a user via tactile sensation or kinesthetic sensation. The haptic module 779 may include, for example, a motor, a piezoelectric element, or an electrical stimulator.

The camera module 780 may capture a still image or moving images. The camera module 780 may include one or more lenses, image sensors, image signal processors, or flashes. The power management module 788 may manage power supplied to the electronic device 701. The power management module 788 may be implemented as at least part of, for example, a power management integrated circuit (PMIC).

The battery 789 may supply power to at least one component of the electronic device 701. The battery 789 may include, for example, a primary cell which is not rechargeable, a secondary cell which is rechargeable, or a fuel cell.

The communication module 790 may support establishing a direct (e.g., wired) communication channel or a wireless communication channel between the electronic device 701 and the external electronic device (e.g., the electronic device 702, the electronic device 704, or the server 708) and performing communication via the established communication channel. The communication module 790 may include one or more communication processors that are operable independently from the processor 720 (e.g., the AP) and supports a direct (e.g., wired) communication or a wireless communication.

The communication module 790 may include a wireless communication module 792 (e.g., a cellular communication module, a short-range wireless communication module, or a global navigation satellite system (GNSS) communication module) or a wired communication module 794 (e.g., a local area network (LAN) communication module or a power line communication (PLC) module). A corresponding one of these communication modules may communicate with the external electronic device via the first network 798 (e.g., a short-range communication network, such as BLUETOOTH™, wireless-fidelity (Wi-Fi) direct, or a standard of the Infrared Data Association (IrDA)) or the second network 799 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 792 may identify and authenticate the electronic device 701 in a communication network, such as the first network 798 or the second network 799, using subscriber information (e.g., international mobile subscriber identity (IMSI)) stored in the subscriber identification module 796.

The antenna module 797 may transmit or receive a signal or power to or from the outside (e.g., the external electronic device) of the electronic device 701. The antenna module 797 may include one or more antennas, and, therefrom, at least one antenna appropriate for a communication scheme used in the communication network, such as the first network 798 or the second network 799, may be selected, for example, by the communication module 790 (e.g., the wireless communication module 792). The signal or the power may then be transmitted or received between the communication module 790 and the external electronic device via the selected at least one antenna.

Commands or data may be transmitted or received between the electronic device 701 and the external electronic device 704 via the server 708 coupled with the second network 799. Each of the electronic devices 702 and 704 may be a device of a same type as, or a different type, from the electronic device 701. All or some of operations to be executed at the electronic device 701 may be executed at one or more of the external electronic devices 702, 704, or 708. For example, if the electronic device 701 should perform a function or a service automatically, or in response to a request from a user or another device, the electronic device 701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 701. The electronic device 701 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus.

Additionally or alternatively, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for managing memory traffic in a memory device, the method comprising:
delaying processing of the memory traffic based on a request threshold and a time threshold; and
initiating or maintaining a power-down state of the memory device during a period in which the memory traffic is delayed.

2. The method of claim 1, further comprising:
incrementing a request counter or a time counter while traffic is delayed, and
comparing the request counter to the request threshold or the time counter to the time threshold.

3. The method of claim 1, wherein the memory traffic is delayed in a case in which a request counter is below the request threshold and a time counter is below the time threshold.

4. The method of claim 1, further comprising processing the memory traffic in a case in which the request threshold or the time threshold is exceeded.

5. The method of claim 1, further comprising resetting the request counter and the time counter in a case in which no traffic is present.

6. The method of claim 1, wherein the power-down state comprises an idle power-down or an active power-down mode of a dynamic random-access memory (DRAM).

7. The method of claim 1, further comprising exiting the power-down state in response to processing the delayed memory traffic.

8. The method of claim 1, further comprising determining the request threshold and the time threshold based on a dynamic operating condition, user policy, or priority level.

9. The method of claim 1, further comprising:
tracking an idle counter; and
initiating the power-down state in a case in which the idle count exceeds an idle threshold.

10. The method of claim 1, wherein delaying processing further comprises postponing transmission of the memory traffic during the period in which the memory traffic is delayed.

11. A memory device for managing memory traffic, the memory device comprising:
a traffic reshaping device configured to delay processing of the memory traffic based on a request threshold and a time threshold; and
a memory controller configured to initiate or maintain a power-down state of the memory device during a period in which the memory traffic is delayed.

12. The memory device of claim 11, wherein the memory controller is further configured to:
increment a request counter or a time counter while traffic is delayed, and
compare the request counter to the request threshold or the time counter to the time threshold.

13. The memory device of claim 11, wherein the traffic reshaping device is further configured to delay the memory traffic in a case in which a request counter is below the request threshold and a time counter is below the time threshold.

14. The memory device of claim 11, wherein the traffic reshaping device is further configured to release the memory traffic for processing in a case in which the request threshold or the time threshold is exceeded.

15. The memory device of claim 11, wherein the memory controller is further configured to reset a request counter and a time counter in a case in which no memory traffic is present.

16. The memory device of claim 11, further comprising a dynamic random-access memory (DRAM) configured to operate in an idle power-down mode or an active power-down mode.

17. The memory device of claim 11, wherein the memory controller is further configured to exit the power-down state in response to processing the delayed memory traffic.

18. The memory device of claim 11, wherein the request threshold and the time threshold are determined based on a dynamic operating condition, user policy, or priority level.

19. The memory device of claim 11, wherein the memory controller is further configured to:
track an idle counter, and
initiate the power-down state in a case in which the idle counter exceeds an idle threshold.

20. The memory device of claim 11, wherein the traffic reshaping device is further configured to postpone transmission of the memory traffic to the memory controller during the period in which the memory traffic is delayed.
